(19) United States
(12) Patent Application Publication
(10) Pub. No.: US 2026/0024242 A1
(43) Pub. Date: Jan. 22, 2026

(54) HEATMAP IN LOW-CODE INTEGRATION ENVIRONMENT

(71) Applicant: Boomi, LP, Conshohocken, PA (US)

(72) Inventors: Ching-Han TU, San Diego, CA (US); Bradley J. DETLEFSEN, West Chester, PA (US); Aditi PAUL, Jersey City, NJ (US)

(73) Assignee: Boomi, LP, Conshohocken, PA (US)

(21) Appl. No.: 18/776,008

(22) Filed: Jul. 17, 2024

(51) Int. Cl. G06T 11/00; G06F 3/04845; G06T 5/50

(52) U.S. Cl. CPC G06T 11/001; G06F 3/04845; G06T 5/50; G06T 2207/20221

(57) ABSTRACT

Conventional problem detection for integration processes in an integration platform is inefficient and requires significant expertise. Disclosed embodiments generate a heatmap as an overlay over the components of an integration process, represented on a virtual canvas. The heatmap may comprise a color map with color regions that each represents the value of one or more predicted and/or actual performance metrics for the components of the integration process overlaid with that color region. Examples of performance metrics include the number of errors, the severity of errors, data throughput, bandwidth utilization, data volume, processing time, and/or the like. The heatmap may comprise a plurality of levels of resolution that may be transitioned between by zooming in and out of the virtual canvas. Higher levels of resolution may comprise indicators conveying additional information about the performance of the corresponding areas.

### BACKGROUND

### Field of the Invention

The embodiments described herein are generally directed to a graphical user interface for a low-code integration environment, and, more particularly, to a heatmap that visually represents the performance of an integration process that is being constructed or modified via a graphical user interface of a low-code integration environment.

### Description of the Related Art

Integration Platform as a Service (iPaaS) enables the integration of applications and data. The iPaaS platform provided by Boomi® of Conshohocken, Pennsylvania, enables users to construct integration processes from pre-built steps, visually represented as “shapes,” which each has a set of configuration properties. Each step dictates how an integration process retrieves data, manipulates data, routes data, sends data, and/or the like. These steps can be connected together in endless combinations to build simple to very complex integration processes.

Recently, there has been a major push to simplify business processes. In particular, it is advantageous when workers can perform daily tasks without requiring special skills or training. This simplifies onboarding and empowers workers to be as efficient and productive as possible.

However, the technical knowledge required to construct integration processes is a barrier to automating the construction process. When constructing an integration process, novice users often have to go through multiple iterations of trial and error before achieving a successful, problem-free implementation. In many cases, a problem may not be discovered until after the integration process has been deployed, which can cause significant disruption to operations.

There are various development tools available in code-heavy integration environments. However, such tools require expertise in coding, and therefore, are not suitable for novice users. In addition, with the exception of real-time syntax checking, such tools require the user to compile and run the code, and then retroactively solve any problems. In other words, the user must first write the code, and then go back and fix the problems in the written code. Currently, there is no tool for preemptively visualizing performance problems before they become engrained in the code, let alone, in a low-code integration environment.

### SUMMARY

Accordingly, systems, methods, and non-transitory computer-readable media are disclosed for a heatmap that visually represents the performance of an integration process that is being constructed or modified via a graphical user interface of a low-code integration environment.

In an embodiment, a method comprises using at least one hardware processor to: generate a graphical user interface comprising a virtual canvas on which shapes, representing components of an integration process, are dragged and dropped to construct the integration process; apply a performance model to integration data, defining the components of integration process, to generate performance data, wherein the performance data comprise one or more performance metrics for each component of the integration process; generate a heatmap comprising a color map, wherein the color map is generated by, for each component of the integration process, mapping at least one value of the one or more performance metrics for that component to at least one color value within a color spectrum, and adding the at least one color value to the color map at a position that corresponds to the shape, representing that component, on the virtual canvas; and display the heatmap as an overlay over the shapes on the virtual canvas in the graphical user interface.

The heatmap may be displayed in response to a user selection of an input within the graphical user interface. The method may further comprise using the at least one hardware processor to remove the heatmap from the graphical user interface in response to a subsequent user selection of the input.

The performance model may comprise a predictive model that predicts a value of at least one of the one or more performance metrics based on the integration data. The method may further comprise using the at least one hardware processor to train the predictive model using historical integration data from a plurality of integration platforms managed through an integration platform as a service (iPaaS) platform. Each of the plurality of integration platforms may be managed by a different organizational account than one or more other ones of the plurality of integration platforms. The at least one performance metric may comprise one or more of a number of errors, a severity of errors, a data throughput, a bandwidth utilization, a data volume, or a processing time.

The one or more performance metrics may comprise one or more of a number of errors, a severity of errors, a data throughput, a bandwidth utilization, a data volume, or a processing time. The one or more performance metrics may be a plurality of performance metrics, wherein the plurality of performance metrics are divided into a plurality of layers, wherein the graphical user interface comprises one or more inputs for toggling on and off each of the plurality of layers, and wherein the heatmap represents all of the plurality of layers that are toggled on.

The graphical user interface may be configured to zoom in to the virtual canvas in response to a first user operation and zoom out of the virtual canvas in response to a second user operation, wherein the heatmap comprises a plurality of levels, including a first resolution and a second resolution, and wherein the method further comprises using the at least one hardware processor to: when zooming in to the virtual canvas, transition from the first resolution to the second resolution; and when zooming out of the virtual canvas, transition from the second resolution to the first resolution. One of the plurality of levels, representing a lowest resolution, may consist of the color map. At least one of the plurality of levels, other than the one of the plurality of levels representing the lowest resolution, may comprise the color map overlaid with one or more indicators, wherein each of the one or more indicators provides information about a performance of an area of the integration process and is overlaid over the color map at a position that corresponds to that area.

At least one of the one or more indicators may comprise a value of at least one of the one or more performance metrics. At least one of the one or more indicators may comprise a natural-language expression that describes the performance of the area. The method may further comprise using the at least one hardware processor to generate the natural-language expression by: generating a prompt using at least a portion of the performance data; and inputting the prompt to a generative language model to produce the natural-language expression.

The heatmap may comprise, for each of a plurality of areas of the integration process on the virtual canvas, a color topography, wherein the color topography comprises at least a first color region around a center of the area and a second color region around a periphery of the first color region. The color topographies for adjacent ones of the plurality of areas may be blended together. For each of the plurality of areas, a size of the first color region and a size of the second color region may be based on a value of the one or more performance metrics corresponding to that area.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for providing a heatmap that visually represents the performance of an integration process, according to an embodiment;

FIG. 4 illustrates a process for providing a heatmap that visually represents the performance of an integration process, according to an embodiment; and

FIGS. 5A-5G illustrate a graphical user interface, according to embodiments.

### DETAILED DESCRIPTION

In an embodiment, systems, methods, and non-transitory computer-readable media are disclosed for a heatmap that visually represents the performance of an integration process that is being constructed or modified via a graphical user interface of a low-code integration environment. Embodiments are intended to increase developer confidence and reduce the learning curve in the construction and understanding of an integration process, by offering contextual assistance through the visualization of problems during the construction or modification process in a low-code integration environment.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

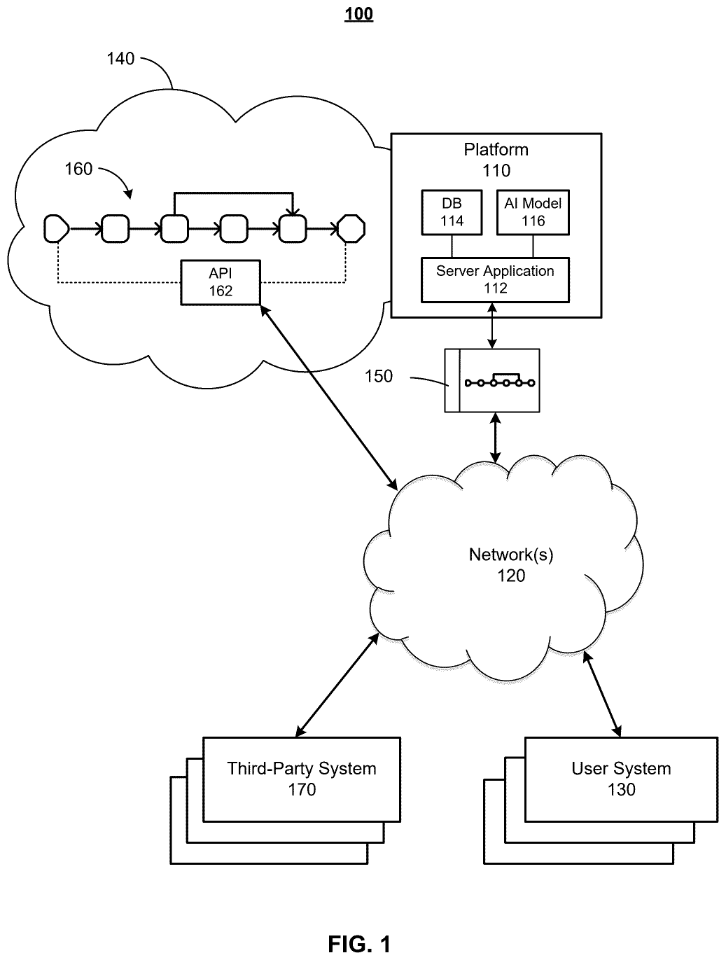

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112, host a database 114 that may store data used by server application 112, and/or execute an artificial intelligence (AI) model 116 that may process data generated by server application 112 and/or stored in database 114 and/or generate data for use by server application 112 and/or storage in database 114. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110. It should be understood that the integration developer may be anywhere from a novice, with little to no prior experience in integration development, to an expert, with many years of experience in integration development. When platform 110 is an iPaaS platform, each user account may be associated with an overarching organizational account for managing an integration platform on the iPaaS platform.

Server application 112 may manage an integration environment 140. In particular, server application 112 may provide a user interface 150 and backend functionality, including one or more of the processes disclosed herein, to enable users, via user systems 130, to construct, develop, modify, save, delete, test, deploy, un-deploy, and/or otherwise manage integration processes 160 within integration environment 140. User interface 150 may comprise a graphical user interface that implements a low-code environment, potentially including a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160. In an embodiment, integration environment 140 supports integration platform as a service (iPaaS). In this case, integration environment 140 may comprise one or a plurality of integration platforms that each comprises one or a plurality of integration processes 160. Each integration platform may be associated with an organization, which may be associated with one or more user accounts by which respective user(s) manage the organization's integration platform, including the various integration process(es) 160.

An integration process 160 may represent a transaction involving the integration of data between two or more systems, and may comprise a series of elements that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including analyzing, normalizing, altering, updated, enhancing, and/or augmenting the received data), and send the manipulated data to one or more specified destinations (e.g., via an application programming interface of each destination). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

Of particular relevance to the present disclosure, the functionality of server application 112 may include a process for constructing an integration process 160 within one or more screens of a graphical user interface of user interface 150. Embodiments of such functionality, which may be implemented in server application 112, to enable the construction of integration processes 160 on a virtual canvas, are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full, and referred to hereafter as “the GUI applications.” In addition, server application 112 may implement functionality to predict errors or other problems with an integration process 160 during construction of that integration process 160. An example of functionality for predicting errors, using artificial intelligence, is disclosed in U.S. patent application Ser. No. 18/438,244, filed on Feb. 9, 2024, which is hereby incorporated herein by reference as if set forth in full, and referred to hereafter as “the error prediction application.”

In an embodiment, a heatmap is generated to visualize the predicted performance of an integration process 160, which may incorporate information about predicted performance metrics, potentially including predicted errors output by an error prediction function (e.g., as disclosed in the error prediction application), during construction of the integration process 160 within the graphical user interface. The user may utilize the heatmap to identify and resolve problems in integration process 160, before finalizing and deploying the integration process 160 to integration environment 140.

Alternatively or additionally, in cases in which integration process 160 has been previously deployed and executed, the heatmap may be generated to visualize the actual performance of integration process 160, which may incorporate information about actual performance metrics, potentially including actual errors in the execution results, during modification or other visualization of the integration process 160 within the graphical user interface. The user may utilize the heatmap to identify and resolve problems in integration process 160 or otherwise debug or troubleshoot integration process 160, before redeploying the integration process 160 to integration environment 140.

As used herein, the term “performance,” whether in reference to predicted or actual performance, should be understood to refer to any attribute related to the operation of an integration process 160, and the term “performance metric,” whether in reference to a predicted or actual performance metric, should be understood to refer to any measure of such an attribute. Thus, while performance metrics will primarily be described herein as representing number and/or severity of errors, data throughput, bandwidth utilization, data volume, processing time, and the like, it should be understood that these are simply examples for the purposes of illustration. Other general examples of performance metrics include, without limitation, cycle time, resource utilization, resource allocation, error rate, workload distribution, throughput, data flow, server load, data quality, user behavior, data characteristics, efficiency, network traffic, status, and the like.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162, and/or pull data from integration process 160 through application programming interface 162.

One or more third-party systems 170 may be communicatively connected to network(s) 120, such that each third-party system 170 may communicate with an integration process 160 in integration environment 140 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

### 2. Example Processing System

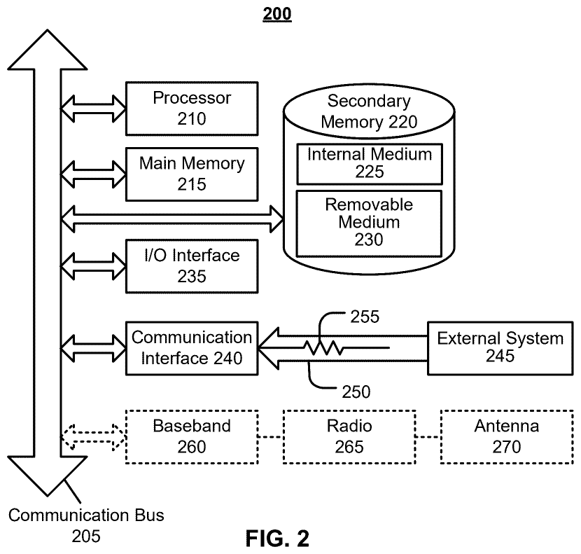

FIG. 2 illustrates an example processing system, by which one or more of the processes described herein may be executed, according to an embodiment. For example, system 200 may be used to store and/or execute server application 112, and/or may represent components of platform 110, user system(s) 130, third-party system 170, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Introduction

The value of an integration platform hinges on its ability to flawlessly transfer and transform data between complex systems. However, as with any complex system, occasional problems are inevitable. Examples of problems include, without limitation, errors, low data throughput, high bandwidth utilization, high data volume, high processing time, and the like. These problems can result from a myriad issues, including, without limitation, coding issues, data transformation or mapping issues, network and connectivity issues, API issues, user errors, and/or the like.

As used herein, the term “error” should be understood to include any execution result that may impact integration process 160. In an embodiment, an execution result comprises any errors and/or warnings that are produced at compile-time and/or runtime of integration process 160. Thus, it should be understood that the term “error,” as used herein, may include both an error event that prevents integration process 160 from continuing to function and a warning event that indicates a problem from which integration process 160 is able to at least partially recover. The term “problem” should be understood to refer more generally to errors and/or any other issue that may negatively impact the performance of an integration process 170, such as low data throughput, high bandwidth utilization, high data volume, high processing time, and the like.

In an embodiment, server application 112 comprises or communicates with a performance prediction function that predicts one or more performance metrics of an integration process 160 during construction of that integration process 160 within the graphical user interface of user interface 150. The performance prediction function may comprise or consist of the error prediction function described in the error prediction application, which preemptively predicts errors in an integration process 160 during construction (i.e., before compile-time and runtime). For example, performance metric(s) may comprise or consist of the number and/or severity of errors, predicted by the error prediction function. Additionally or alternatively, the performance metric(s) may comprise or consist of one or more key performance indicators (KPIs) for each of one or more components (e.g., a step, a connection between two steps, etc.) or subsets of components (e.g., groups of two or more steps and/or connections) in the integration process 160 being constructed. Examples of key performance indicators include, without limitation, data throughput, bandwidth utilization, data volume, processing time, and the like. Server application 112 may either implement the performance prediction function itself, or receive the output of a separate performance prediction function that is external to server application 112.

In an alternative or additional embodiment, server application 112 comprises or communicates with a performance monitoring function that monitors or tracks one or more performance metrics of an integration process 160 during compile-time or runtime of that integration process 160 within integration environment 140. These performance metrics may be the same as the predicted performance metrics described above, including, for example, the number of errors, severity of errors, data throughput, bandwidth utilization, data volume, processing time, and/or the like. However, in this case, the values of the performance metrics are actual (i.e., historical) values, as opposed to predicted values. Server application 112 may either implement the performance monitoring function itself, or receive the output of a separate performance monitoring function that is external to server application 112.

Visual information is critical for low-code environments, such as the iPaaS platform provided by Boomi®. Disclosed embodiments utilize a heatmap, overlaid on an integration process 160 being constructed within a graphical user interface of user interface 150, to visually represent the predicted or actual performance metrics of each of one or more, including potentially all, of the components (e.g., steps, connections, etc.) within the integration process 160. The graphical user interface may enable a user to drill down into (e.g., zoom into) the heatmap to provide a more granular visualization of any arbitrary area of the integration process 160. Thus, a user can drill down into a particular area of interest for a better understanding of the performance metric(s) in that area of interest.

Advantageously, the heatmap enables users to quickly, intuitively, and holistically visualize and interpret patterns, clusters, correlations, trends, and variations in the performance data for an integration process 160. Disclosed embodiments of the heatmap may help users identify and resolve (e.g., troubleshoot or debug) problems in the integration process 160, identify areas of interest in the integration process 160, spot outliers in the performance data, assess and improve the quality of the integration process 160, make informed decisions based on the distribution of the performance data, and/or the like.

### 4. Data Flow

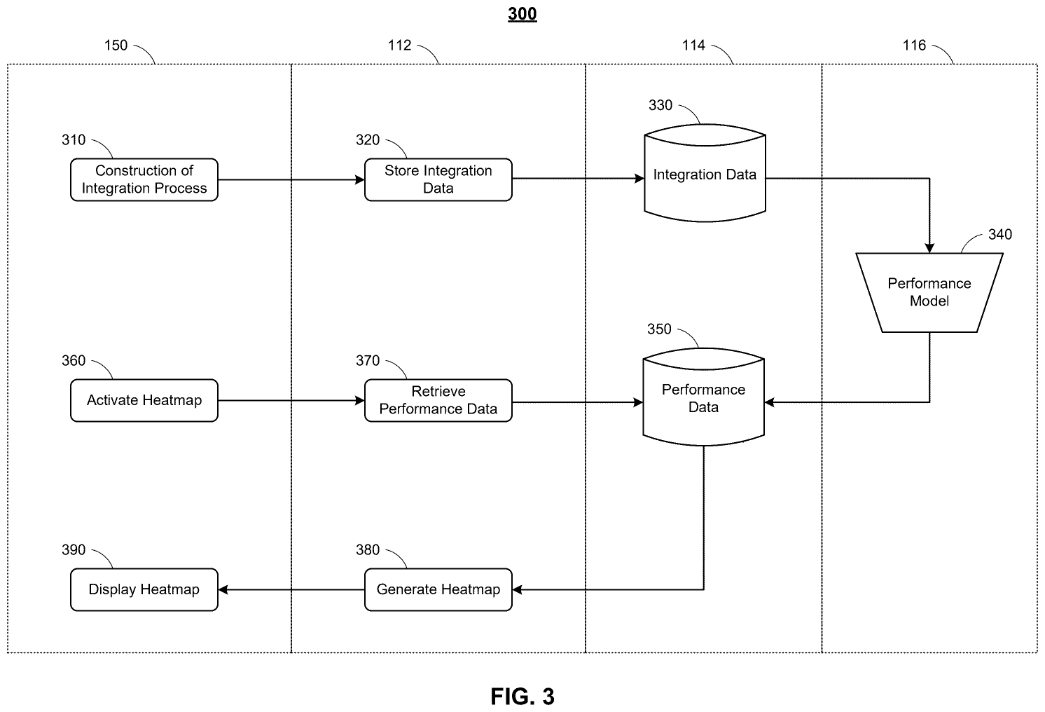

FIG. 3 illustrates an example data flow 300 for providing a heatmap that visually represents the performance of an integration process 160, according to an embodiment. In data flow 300, user interface 150 may implement modules 310, 360, and 390, server application 112 may implement modules 320, 370, and 380, database 114 may store integration data 330 and performance data 350, and AI model 116 may comprise performance model 340. Modules 310, 320, 360, 370, 380, and 390, and performance model 340 are preferably implemented as software modules, but could also be implemented as hardware modules or as modules comprising a combination of hardware and software.

Using module 310, a user may begin constructing an integration process 160 within user interface 150. For example, user interface 150 may comprise or consist of a graphical user interface that comprises a virtual canvas on which a user may drag and drop and connect shapes, representing steps that perform specific functions within an integration process 160. Thus, the user may intuitively construct an integration process 160 by simply placing shapes on the virtual canvas and connecting those shapes together, to define data flows between the steps represented by those shapes.

At one or more points in time, during construction of integration process 160 via module 310, module 320 may be executed in response to a trigger. When triggered, module 320 may store integration data 330, representing the integration process under construction, in database 114. Integration data 330 may comprise one or more data structures that represent the current components of integration process 160, such as any steps, connections between steps, and/or the like, including, potentially, the configuration of each component. It should be understood that integration data 330 may be stored in any standard format, according to a predefined data schema.

In an embodiment, the trigger of module 320 is a user operation. For instance, the user may select a save input for saving integration process 160, an analyze input for analyzing integration process 160, and/or another input within user interface 150, to trigger module 320. Alternatively or additionally, module 320 may be triggered in the background (i.e., automatically, without user involvement), periodically (e.g., after each expiration of a time interval of several seconds, minutes, etc.), in real time in response to an event, such as a modification to integration process 160 via the virtual canvas, and/or the like. It should be understood that, as used herein, the terms “real time” and “real-time” refer to events that occur simultaneously, as well as events that are separated in time due to ordinary latencies in processing, communications, memory access, and/or the like.

In an embodiment, integration data 330 are input to a performance model 340 of AI model 116. For example, performance model 340 may be executed on the current integration data 330 in the background (e.g., automatically), periodically (e.g., every few seconds or minutes), in real time in response to an event, such as the selection of an input within user interface 150, a modification to integration process 160 via the virtual canvas, or another user operation, and/or the like. The trigger of performance model 340 may be the same as or different from the trigger of module 320. The input to performance model 340 may comprise the raw integration data 330 and/or pre-processed integration data 330. Performance model 340 may comprise rule-based or logic-based artificial intelligence, a trained machine-learning model, and/or the like, which are applied to integration data 330. In an embodiment, performance model 340 may comprise the error prediction function described in the error prediction application. Regardless of the particular implementation, performance model 340 may generate performance data 350 based on integration data 330.

In an embodiment, performance model 340 comprises a predictive model that predicts a value of each of one or more performance metrics based on integration data 330. This predictive model may be used prior to any deployment of integration process 160, since actual performance metrics will not yet be available for the integration process 160. The predictive model may comprise a machine-learning model, such as an artificial neural network (e.g., a deep-learning neural network (DNN), recurrent neural network (RNN), graph neural network (GNN), or the like), a random forest algorithm, a linear regression algorithm, a logistic regression algorithm, a decision tree, a support vector machine (SVM), a naïve Bayes algorithm, a k-Nearest Neighbors (kNN) algorithm, a K-means algorithm, a dimensionality reduction algorithm, a gradient-boosting algorithm, a Markov chain, a compact prediction tree (CPT), and/or the like.

The predictive model may be trained using historical integration data, which may comprise representations of previously constructed and executed integration processes, as well as the execution results, including any errors, key performance indicators, and/or other actual performance metrics, associated with those integration processes 160. The historical integration data may be collected from a plurality of integration platforms managed through and executed by an iPaaS platform, such as the Boomi® iPaaS platform. The iPaaS platform may support a plurality of integration platforms, each managed by a different organizational account that is associated with one or more user accounts. In this case, the historical integration data may represent a massive repository of previously executed integration processes 160 that is very diverse in terms of structures, configurations, applications, inputs and outputs, and the like, and potentially crowd-sourced from a diverse group of organizations.

In an additional or alternative embodiment, performance model 340 may comprise logic that extracts, computes, or otherwise derives an actual value of each of one or more performance metrics based on integration data 330. This logic may be used when integration process 160 has been previously deployed and executed, such that actual execution results are available for integration process 160. The logic may retrieve the execution results for previous compile-time(s) and/or runtime(s) of integration process 160 from database 114, and derive the actual values of the performance metric(s) from the retrieved execution results.

In either case, performance data 350 may comprise the value, whether actual or predicted, of each of one or more performance metrics for the integration process 160 that is represented by integration data 330. Performance data 350 may comprise, for each of at least a subset of components in integration process 160, an indication (e.g., identifier) of that component and the value of each performance metric for that component. The subset of components that are represented in performance data 350 and which are associated with a value of each performance metric may comprise all steps in integration process 160 and/or all connections in integration process 160. Alternatively, the subset of components may consist of fewer than all of the steps in integration process 160 and/or fewer than all of the connections in integration process 160. Examples of performance metrics for a component include, without limitation, a number of errors for that component, a severity of errors for that component, a data throughput for that component, a bandwidth utilization for that component, a data volume for that component, a processing time for that component, and/or the like. Performance data 350 may comprise either an actual value or predicted value for any given performance metric.

At one or more points in time, during construction of integration process 160 in module 310, module 360 of user interface 150 may be triggered to activate the heatmap. Module 360 may be triggered by a user operation. For instance, the user may toggle a heatmap input from an inactive state to an active state. Alternatively or additionally, module 360 may be triggered by another function, such as execution of performance model 340 on integration data 330. For example, a user may select an analyze input within user interface 150, which may trigger the application of a predictive model of performance model 340 to current integration data 330, to produce new performance data 350. In this case, module 360 could be automatically triggered to display the result of the analysis as a heatmap. It should be understood that, even in this case, user interface 150 may comprise a heatmap input that enables the user to toggle the heatmap off (i.e., deactivate the heatmap) or on again.

Whenever the heatmap is activated, module 370 of server application 112 may retrieve performance data 350 for processing by module 380 of server application 112. Module 380 may then generate the heatmap based on performance data 350. The heatmap may be generated as an overlay to be displayed over the shapes, representing integration process 160, on the virtual canvas in the graphical user interface of user interface 150.

In an embodiment, the heatmap comprises at least a color map. The color map for a given performance metric may be generated by converting the value of the performance metric for each component to a color value within a color spectrum. The color spectrum may be a set of discrete color values (e.g., red, yellow, green) or a continuous range of color values (e.g., from red to green). In either case, the color value that is selected from the spectrum of color values depends on the value of the respective performance metric. In general, module 380 may generate the color map by, for each component of integration process 160, mapping the value of a performance metric for that component to a color value within the color spectrum, and adding the color value to the color map at a position that corresponds to the shape, representing that component, on the virtual canvas.

In an embodiment, a minimum possible value of the respective performance metric corresponds to a color value on one end of the color spectrum and a maximum possible value of the respective performance metric corresponds to a color value on the opposite end of the color spectrum. In general, a value that represents a more negative impact on the performance of integration process 160 may be associated with a more alarming color value, such as red, whereas a value that represents a more positive impact on the performance of integration process 160 may be associated with a more soothing color value, such as green. A value that represents a neutral impact or no impact on the performance of integration process 160 may be associated with a neutral color value, such as yellow, gray, blue, or the like.

Module 380 may generate the color map using logic. For example, module 380 may determine the minimum value of the performance metric (e.g., across all components in integration process 160) within performance data 350 and the maximum value of the performance metric (e.g., across all components in integration process 160) within performance data 350. Then, the minimum value may be mapped to one end of the color spectrum and the maximum value may be mapped to the opposite end of the color spectrum. Finally, all other values of the performance metric may be mapped to the color spectrum, proportionally to their numeric positions between the minimum and maximum values. In this manner, the color mapping is relative to the range of values in performance data 350. Alternatively, a color spectrum may be pre-mapped to a fixed range that accounts for all possible values for the performance metric. In this case, the values of the performance metric are mapped to the color spectrum according to their relative positions within the fixed range.

Alternatively or additionally, module 380 may generate the color map using a machine-learning model (not shown). In this case, AI model 116 may comprise the machine-learning model, and module 380 may input performance data 350 into the machine-learning model, which is trained to output the color map based on performance data 350. For example, the values of a single performance metric for components of integration process 160 may be input into the machine-learning model to produce a color map of the single performance metric for the entire integration process 160. As another example, the values of two or more performance metrics for components of integration process 160 may be input into the machine-learning model to produce a composite color map of the two or more performance metrics for the entire integration process 160. As another example, the values of one or more performance metrics for a single component of integration process 160 may be input into the machine-learning model to produce a color map of the one or more performance metrics for that single component. In this latter case, the color maps for all of the components may then be combined into a composite color map of the one or more performance metrics for the entire integration process 160.

It should be understood that the performance metrics in performance data 350 are each associated with a set of one or more components in integration process 160. Thus, the color values that are mapped to the values of each performance metric will also each be associated with a set of one or more components in integration process 160. Accordingly, the color values, representing the values of the performance metrics, may be mapped to the visual representations (i.e., shapes) of the respective components to produce the color map. As a result, the heatmap may comprise a color map that maps color values to the particular positions on the virtual canvas at which the respective components are positioned. Thus, similarly to how a weather map represents weather metrics (e.g., temperature, precipitation, etc.) as colors overlaid on respective regions of a virtual map, the color map may comprise colors, representing performance metrics, overlaid on respective components on a virtual canvas of user interface 150.

The heatmap may comprise one or more other indicators, such as text and/or icons, in addition to the color map. These other indicators may be overlaid over the color map at a position that corresponds to the shape(s) or other area of integration process 160 to which each indicator pertains. Each indicator may indicate the value of a performance metric or provide other information about the performance of the area over which the indicator is overlaid. For example, the indicator may comprise or otherwise represent the value of a performance metric for the given area of integration process 160. In this case, the indicator may represent the raw value of the performance metric for the area (e.g., a single shape, or combination of shapes), or may represent a processed or aggregate value of the performance metric for the area. Alternatively, the indicator may comprise a natural-language expression that describes the performance of the area over which the indicator is overlaid. In this case, the indicator may be overlaid over the color map at a position that corresponds to the area using a call-out from the position to an offset dialog box comprising the natural-language expression. As used herein, the term “natural language” or “natural-language” refers to language, including grammar, that would be expected in a normal conversation between two humans.

Module 390 displays the heatmap, generated by module 380, as an overlay over the shapes of integration process 160 on the virtual canvas of user interface 150. The color map of the heatmap may be partially transparent, such that the shapes, representing components of integration process 160, are visible through the color map. Thus, the user can quickly and intuitively understand the performance of each component of integration process 160 by simply viewing the color overlaid over the shape that represents that component, and can understand the performance of each area of integration process 160 by simply viewing the colors overlaid over that area.

User interface 150 may enable the user to zoom in and out of the virtual canvas, in a similar or identical manner as with a standard virtual map. This enables the user to zoom in to an area of interest of integration process 160, or zoom out to view integration process 160 as a whole. In particular, when the user zooms in to the virtual canvas, a portion of integration process 160 around the center of the virtual canvas may expand in size, while peripheral portions of integration process 160 may disappear from the virtual canvas to make room for the expanded area. Conversely, when the user zooms out of the virtual canvas, a portion of integration process 160 around the center of the virtual canvas may collapse in size, while peripheral portions of integration process 160 come into view on the virtual canvas by filling in the space vacated by the collapsed area.

In an embodiment, the heatmap comprises a plurality of levels of detail or resolution. As a user zooms in to the virtual canvas, the level of detail may increase in terms of resolution or granularity. Conversely, as the user zooms out of the virtual canvas, the level of detail may decrease in terms of resolution or granularity. At the lowest level of detail (i.e., lowest resolution), the heatmap may consist of only the color map. At higher levels of detail, the heatmap may comprise both the color map and one or more indicators representing more specific information about each of one or more visible areas of the heatmap. As discussed elsewhere herein, these indicator(s) may comprise numeric text or icons representing specific values for the performance metrics in each area. At the highest level of detail (i.e., highest resolution), these specific values of performance metrics may represent the most granular values available for the performance metrics in each area, including potentially for each individual step, connection, other component, or set of components in the area. At intermediate levels of detail, these specific values may represent aggregated values for the performance metrics in each area. Alternatively or additionally, these indicator(s) may comprise alphanumeric text, including potentially natural language, that describes the performance of a given region. In any case, as a user zooms in to the virtual canvas with the overlaid heatmap, the data may become more granular as the level of detail increases from just the color map, to a color map with one or more indicators overlaid on the color map, until, at the highest level of detail, the indicator(s) may comprise raw values of performance metrics or natural-language descriptions of performance overlaid on the color map. This enables the user to understand top-level trends in the performance of integration process 160, as well as the data that support those trends. Conversely, as the user zooms out of the virtual canvas with the overlaid heatmap, the data may become less granular as the level of detail increases until, at the lowest level of detail, the heatmap consists of only the color map again.

In an embodiment, for one or more levels of detail that include text, the text may be generated using a generative language model (not shown) comprised within AI model 116. For instance, as discussed elsewhere herein, an indicator in the level of detail may comprise a natural-language expression that describes the performance of an area of integration process 160 on the virtual canvas. In an embodiment, this natural-language expression is automatically generated using a generative language model.

In particular, module 380 may generate a prompt using at least a portion of performance data 350, for example, by inserting one or more performance metrics and/or other performance data 350 into a predefined template. The predefined template may comprise a pre-conversation and/or post-conversation, which provide context and/or instructions for the generative language model, and a placeholder into which the performance metrics and/or other performance data 350 are inserted. The pre-conversation and/or post-conversation may define the role of the generative language model (e.g., to summarize the performance metrics), define an output format for the generative language model (e.g., a list structure, a hierarchical structure, a markup-language structure, etc.), and/or the like.

Module 380 may input the generated prompt to the generative language model to produce an output, which may comprise a natural-language expression, a data structure representing a visual dialog to be rendered in user interface 150 as the indicator, and/or the like. The generative language model may comprise or consist of a large language model, such as the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models. Alternatively or additionally, the generative language model may comprise or consist of a code-completion model that is trained to produce data structures, such as visual dialogs, to be rendered in a graphical user interface. In an embodiment, a pre-trained generative language model is used as a base model that is fine tuned for the specific task of conveying performance metrics, to produce the generative language model of AI model 116.

Module 380 may receive the output of the generative language model in response to the prompt. The output may comprise or consist of a summary of the performance metrics or other summary of performance of the respective area of integration process 160. This output may be expressed in natural language, a data structure representing a visual dialog, comprising the natural-language expression, to be rendered in user interface 150, and/or the like. When receiving a natural-language expression from the generative language model, module 380 may process the output by formatting the output into a visual representation, as the indicator, that is overlaid on the color map at the position of the area to which the natural-language expression pertains. As an example, the indicator may comprise a dialog that includes the natural-language expression and potentially one or more inputs for interacting with the dialog.

In an alternative embodiment, instead of using a generative language model, the natural-language expression of an indicator may be generated by processing performance data 350 directly into data structures representing dialogs to be rendered over the color map. The data structure may be generated by applying logic (e.g., comprising a set of one or more rules) to the performance metrics. For example, the logic may automatically convert the performance metric(s) for each area into a visual dialog based on a template for each level of detail. In particular, a natural-language expression may be generated by retrieving a predefined template, comprising natural language with one or more placeholders, and inserting specific value(s) of one or more performance metrics into the placeholder(s), to produce the natural-language expression.

In an embodiment, the heatmap may comprise a plurality of layers of performance metrics. In this case, each of the plurality of layers may comprise a different set of one or more performance metrics for each of the components of integration process 160 represented in performance data 350. In other words, performance data 350 may comprise a plurality of performance metrics that are divided into a plurality of layers within the heatmap. In a preferred embodiment, each layer may consist of a single performance metric. It is generally contemplated that the plurality of layers would be non-overlapping, such that no performance metric is represented across two or more layers of the heatmap. However, in an alternative embodiment, the plurality of layers may be overlapping, such that one or more performance metrics are represented in two or more layers of the heatmap.

As an example, an error layer may comprise the number of errors and/or the severity of errors in each component or set of components that is represented in performance data 350. As another example, a throughput layer may comprise a measure of data throughput for each component or set of components that is represented in performance data 350. The measure of data throughput may comprise, for instance, bits per second (bps), megabytes per second (MB/s), gigabytes per second (GB/s), or the like, passing through the respective component or set of components. As another example, a bandwidth layer may comprise a measure of bandwidth utilization by each component or set of components that is represented in performance data 350. The measure of bandwidth utilization may be a percentage of used bandwidth to total available bandwidth for the respective component or set of components. As another example, a volume layer may comprise a measure of data volume that passes through each component or set of components that is represented in performance data 350. The measure of data volume may comprise, for instance, an amount of data in kilobytes, megabytes, gigabytes, terabytes, petabytes, or the like, passing through the respective component or set of components. As another example, a timing layer may comprise a measure of processing time required by each component or set of components that is represented in performance data 350. The measure of processing time may comprise, for instance, a mean or median processing time (e.g., per unit of data) or total processing time, in milliseconds, seconds, minutes, or the like, required by the respective component or set of components.

In an embodiment in which the heatmap comprises a plurality of layers of performance metrics, user interface 150 may comprise one or more inputs for toggling individual layers on or off. Module 380 may generate the heatmap for the subset of one or more layers that are currently toggled on. If two or more layers are currently toggled on, module 380 may generate an individual heatmap for each of the two or more layers and then combine the individual heatmaps into a composite heatmap. Alternatively, module 380 may generate a collective heatmap for the two or more layers without first generating individual heatmaps for each layer. In an alternative embodiment, the user may be restricted to selecting a single layer at a time.

### 5. Process

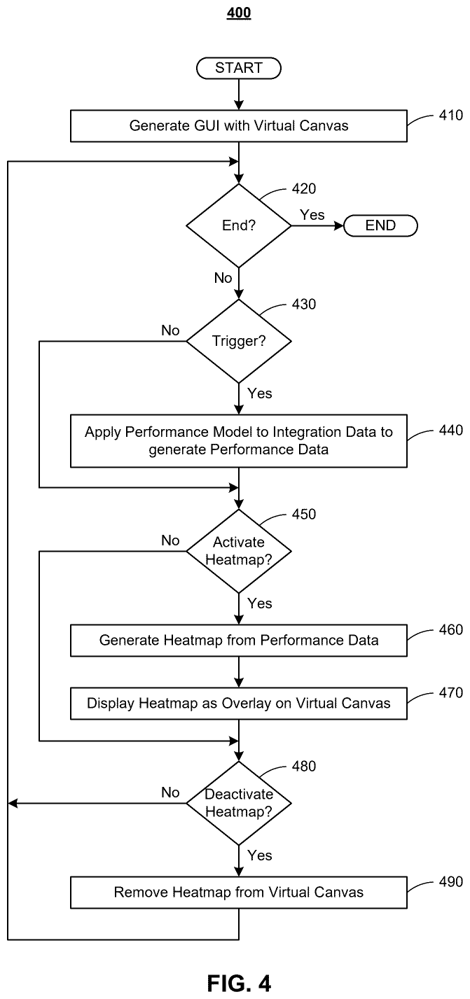

FIG. 4 illustrates a process 400 for providing a heatmap that visually represents the performance of an integration process 160, according to an embodiment. Process 400 may be implemented in server application 112. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Initially, in subprocess 410, a graphical user interface of user interface 150 may be generated. The graphical user interface may comprise a virtual canvas on which shapes, representing components of an integration process 160, are dragged and dropped to construct the integration process 160. In particular, in parallel to process 400, the user may drag shapes, representing steps, onto the virtual canvas, and then connect those shapes. Embodiments of the graphical user interface are disclosed in the GUI applications.

In subprocess 420, process 400 may determine whether or not to end. Process 400 may determine to end when the user navigates away from the current screen (i.e., comprising the virtual canvas) of the graphical user interface, when the user selects an input that deploys the integration process 160, and/or the like. When determining to end (i.e., “Yes” in subprocess 420), process 400 may end. Otherwise, when not determining to end (i.e., “No” in subprocess 420), process 400 may proceed to subprocess 430.

In subprocess 430, process 400 may determine whether or not to trigger execution of performance model 340. Process 400 may determine to trigger the execution of performance model 340 in response to a user operation (e.g., the user selection of a specific input in the graphical user interface), automatically in response to a modification to integration process 160 on the virtual canvas, automatically in response to the expiration of a time interval (e.g., periodically), and/or the like. When determining to trigger the execution of performance model 340 (i.e., “Yes” in subprocess 430), process 400 may proceed to subprocess 440. Otherwise, when not determining to trigger the execution of performance model 340 (i.e., “No” in subprocess 430), process 400 may proceed to subprocess 450.

In subprocess 440, performance model 340 may be applied to integration data 330 to generate performance data 350, as described in greater detail elsewhere herein. Integration data 330 may define the components of the integration process 160 being constructed on the virtual canvas. Performance data 350 may comprise one or more performance metrics for each of these components of integration process 160. The performance metric(s) may comprise one or more of a number of errors, a severity of errors, a data throughput, a bandwidth utilization, a data volume, or a processing time.

Performance model 340 may comprise a predictive model that predicts the value of one or more, including potentially all, of the performance metric(s) based on integration data 330. In this case, the value of each of one or more of the performance metric(s) may be a predicted value. The predictive model may be trained using historical integration data from a plurality of integration platforms managed through platform 110 as an iPaaS platform. Each of the plurality of integration platforms may be managed by a different organizational account than one or more other ones of the plurality of integration platforms, to provide a diverse set of training data.

Alternatively or additionally, performance model 340 may comprise a logical model that, when the integration process 160 on the virtual canvas has been previously deployed, such that execution results are available, derives the actual value of one or more, including potentially all, of the performance metric(s) based on integration data 330 and the execution results. In particular, the logical model may extract, compute, or otherwise derive the actual value of each performance metric from execution results associated with each component and/or set of components that is represented on the virtual canvas.

In subprocess 450, process 400 may determine whether or not to activate the heatmap. Process 400 may determine to activate the heatmap in response to a user operation (e.g., the user selection of a specific input for toggling on the heatmap in the graphical user interface), automatically after an analysis (e.g., error prediction function) has been executed on integration process 160, and/or the like. When determining to activate the heatmap (i.e., “Yes” in subprocess 450), process 400 may proceed to subprocess 460. Otherwise, when not determining to activate the heatmap (i.e., “No” in subprocess 450), process 400 may proceed to subprocess 480.

In subprocess 460, the heatmap is generated from performance data 350 by module 380. The heatmap comprises at least a color map. The color map may be generated by, for each component of integration process 160, mapping each value of the performance metric(s) for that component to a color value within a color spectrum, and adding the color value to the color map at a position that corresponds to the shape, representing that component, on the virtual canvas. Adding the color value to the color map may comprise adding a region (i.e., one or a plurality of pixels) of the color value to the color map at the respective position. In an additional embodiment of the heatmap, one or more indicators of one or more performance metrics may be overlaid on the color map, as described elsewhere herein.

Performance data 350 may be mapped to the shapes of their respective components on the virtual canvas of the graphical user interface. For instance, performance data 350 may indicate the component(s) of integration process 160 to which each performance metric in performance data 350 pertains. This indication of a component may comprise a unique identifier of the component to which the performance metric(s) pertain, a type of the component to which the performance metric(s) pertain, a description of the component to which the performance metric(s) pertain, and/or the like. Thus, each performance metric may be matched to one or more specific components in integration process 160 during generation of the heatmap.

In subprocess 470, the heatmap may be displayed, as an overlay on the virtual canvas in the graphical user interface, by module 390. In particular, the heatmap is displayed over the shapes on the virtual canvas, such that the color values in the color map and/or any indicators are positioned over or near the areas (e.g., shapes or sets of shapes) of integration process 160 to which they pertain. The color map may comprise, for each of a plurality of areas of integration process 160 on the virtual canvas, a color topography. Each color topography may comprise at least a first color region around a center of the respective area and a second color region around a periphery of the first color region. Within the color map, the color topographies for adjacent areas may be blended together to provide a smooth transition between the outer color regions of the adjacent color topographies.

In an embodiment, the heatmap may comprise a plurality of levels of resolution, including two or more resolutions. One of the plurality of levels, representing the lowest resolution, may consist solely of the color map. At least one, and potentially all, of the plurality of levels, other than the level representing the lowest resolution, may comprise the color map overlaid with one or more indicators. Each of the indicator(s) may provide information about a performance of an area of integration process 160 and be overlaid over the color map at a position that corresponds to that area. As discussed elsewhere herein, an indicator may comprise a value of a performance metric (e.g., the actual or predicted value of the performance metric for a single component, an aggregate actual or predicted value of the performance metric for a set of two or more components, etc.), a natural-language expression that describes the performance of the area at which the indicator is positioned, and/or the like. In the case of a natural-language expression, the natural-language expression may be generated using a predefined template or by a generative language model. In the case that a generative language model is used, the natural-language expression may be generated by generating a prompt using at least a portion of performance data 350, and inputting the prompt to a generative language model (e.g., in AI model 116) to produce the natural-language expression.

The graphical user interface may be configured to zoom in to the virtual canvas in response to a first user operation (e.g., selection of a first user input, scrolling of a mouse wheel in a first direction, pinch-out gesture on a touch-panel display, etc.) and zoom out of the virtual canvas in response to a second user operation (e.g., selection of a second user input, scrolling of a mouse wheel in a second direction, pinch-in gesture on a touch-panel display, etc.). In an embodiment in which the heatmap comprises the plurality of levels, the plurality of levels will include at least a first or lower resolution and a second or higher resolution. When zooming in to the virtual canvas, the heatmap may transition from the first resolution to the second resolution. Conversely, when zooming out of the virtual canvas, the heatmap may transition from the second resolution to the first resolution. It should be understood that there may be any number of resolutions within the plurality of levels, and that more generally, zooming in will transition from lower resolutions to higher resolutions, whereas zooming out will transition from higher resolutions to lower resolutions. It should also be understood that the transitions may occur at specific zoom levels. Between those zoom levels, zooming in or out may simply expand or collapse, respectively, the visible region of integration process 160 without transitioning to a new level of resolution.

In an embodiment in which performance data 350 comprise a plurality of performance metrics, the plurality of performance metrics may be divided into a plurality of layers. In this case, the graphical user interface may comprise one or more inputs for toggling on and off each of the plurality of layers. The input(s) may comprise a checkbox for each layer, such that the user may toggle on a single layer or a combination of two or more layers at a time. Alternatively, the input(s) may comprise a menu (e.g., drop-down menu) from which the user is only able to select a single layer to toggle on at a time. The heatmap may represent all of the layers that have been toggled on. In an embodiment in which the user is able to toggle on a combination of layers, the heatmap may comprise individual semi-transparent layers that are overlaid on each other to represent the selected combination of layers. Alternatively, the heatmap may be generated with a composite color map and/or composite indicators that aggregate all of the performance metrics in the selected combination of layers. It should be understood that each of the layers of the heatmap may comprise the plurality of levels of resolution, such that the user may adjust the resolution of the layer(s), currently toggled on (i.e., such that they are represented in the heatmap), by zooming in or out of the virtual canvas.

In an embodiment in which the heatmap comprises a plurality of levels and/or may comprise any one or more of a plurality of layers, each level and/or layer may be generated in advance by module 380 (e.g., whenever performance data 350 are generated, whenever integration process 160 is modified in the virtual canvas, in response to a user operation, when an analysis on integration process 160 is performed, the first time the heatmap is activated, etc.). This may allow for smoother (i.e., quicker) transitions between levels and/or layers, since all of the levels and/or layers are already available for rendering. Alternatively, each level and/or layer may be generated in real time as the user zooms in or out and/or toggles layers on or off, respectively. While this may result in choppier transitions, it may reduce overall computational time for generating the heatmap, since not all levels and/or layers will necessarily need to be generated. However, even in this case, levels of resolution may be prefetched based on the direction of zooming, to provide for smoother transitions between levels.

In subprocess 480, process 400 determines whether or not to deactivate the heatmap. Process 400 may determine to deactivate the heatmap in response to a user operation (e.g., the user selection of a heatmap input for toggling off the heatmap in the graphical user interface). When determining to deactivate the heatmap (i.e., “Yes” in subprocess 480), process 400 may proceed to subprocess 490. Otherwise, when not determining to deactivate the heatmap (i.e., “No” in subprocess 490), process 400 may return to subprocess 420.

In subprocess 390, process 400 may remove the heatmap from the graphical user interface. In this case, the heatmap input for toggling on or off the heatmap may be updated to reflect that the heatmap is currently deactivated. It should be understood that the heatmap may be retained in memory (e.g., database 114), such that it can be quickly and easily displayed again if a subsequent user operation toggles the heatmap back on (e.g., by reselecting the heatmap input).

### 6. Graphical User Interface

Boomi® provides an iPaaS platform that has revolutionized the integration/middleware space with a drag-and-drop graphical user interface that eliminates the need for custom code in the construction of integration processes 160. In particular, the graphical user interface comprises a virtual canvas over which a user may drag and drop shapes, representing steps that perform specific functions, and connect the shapes to define data flows between their respective functions. Thus, the user may intuitively construct an integration process 160 by simply adding, configuring, and connecting shapes in an intuitive manner, within a low-code integration environment.

However, prior to deployment, developers are often uncertain about whether or not the integration processes 160 that they construct will actually run and/or meet performance requirements. Accordingly, disclosed embodiments provide an easy-to-use, intuitive graphical user interface with a top-down approach for generalizing and interpreting potential performance problems in an integration process 160 under construction. This graphical user interface may be used by both novice and expert developers to efficiently troubleshoot their integration processes 160 prior to deployment. An embodiment of this graphical user interface is described below.

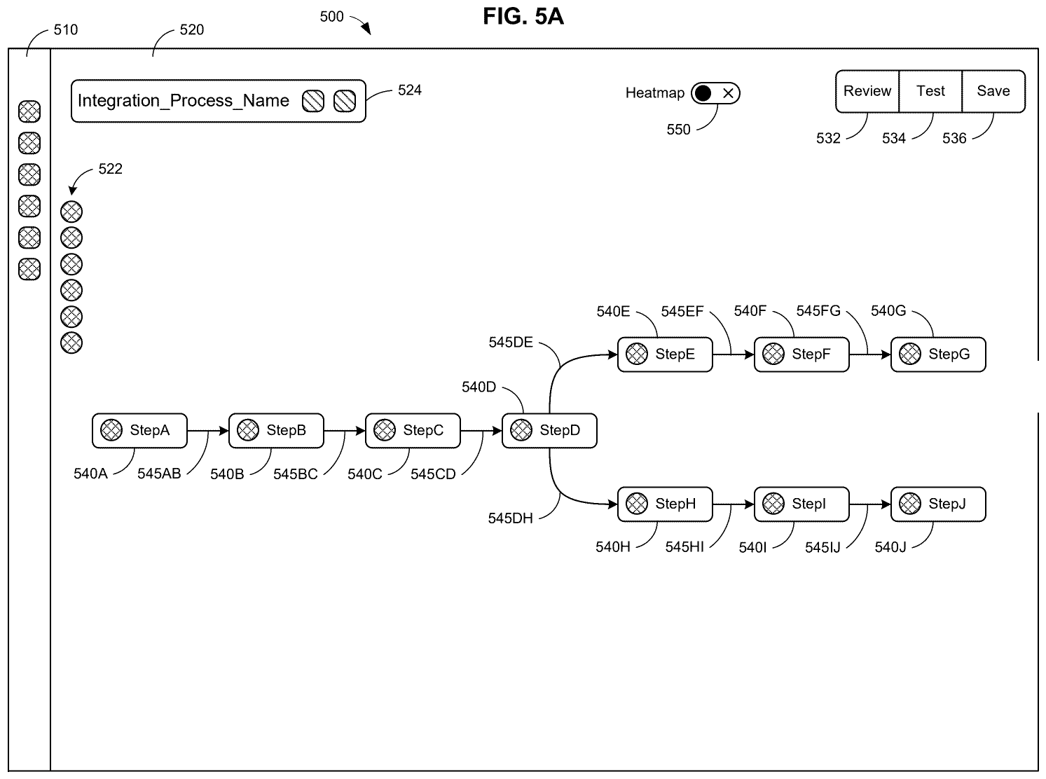

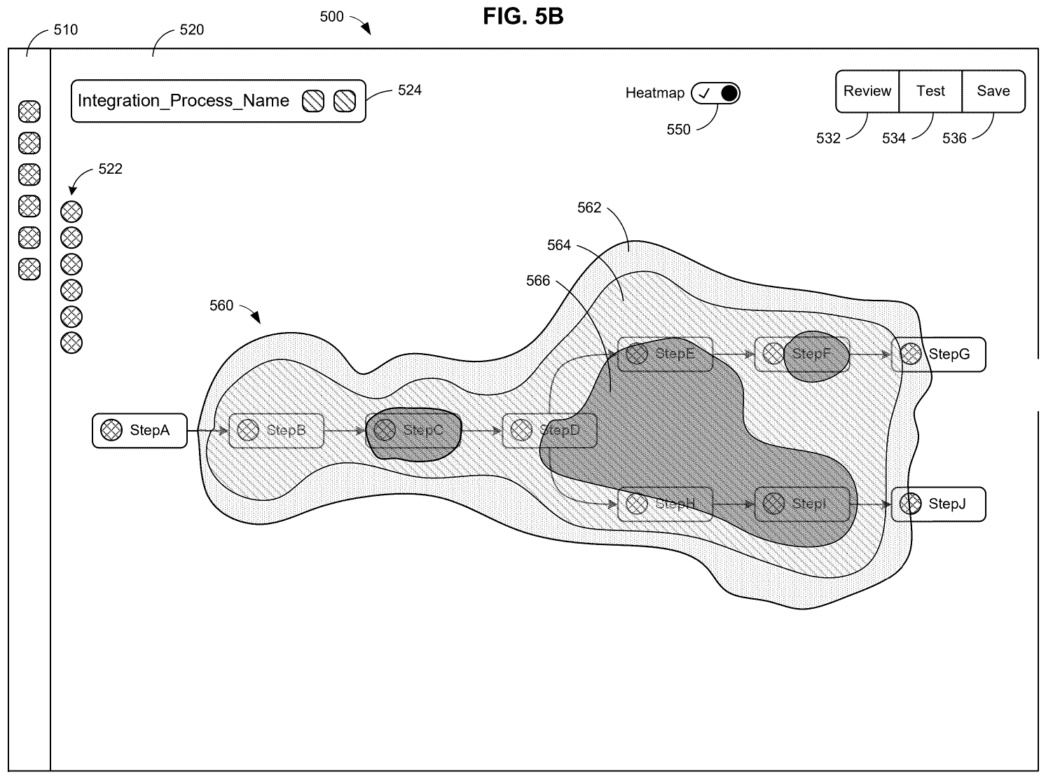

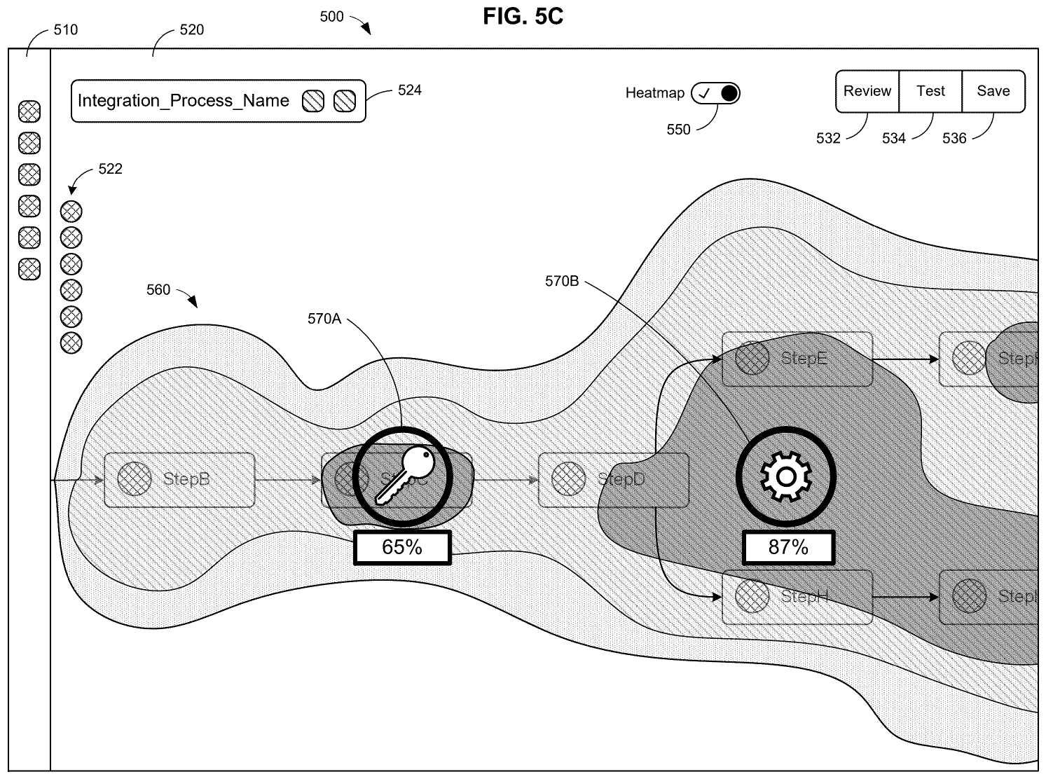

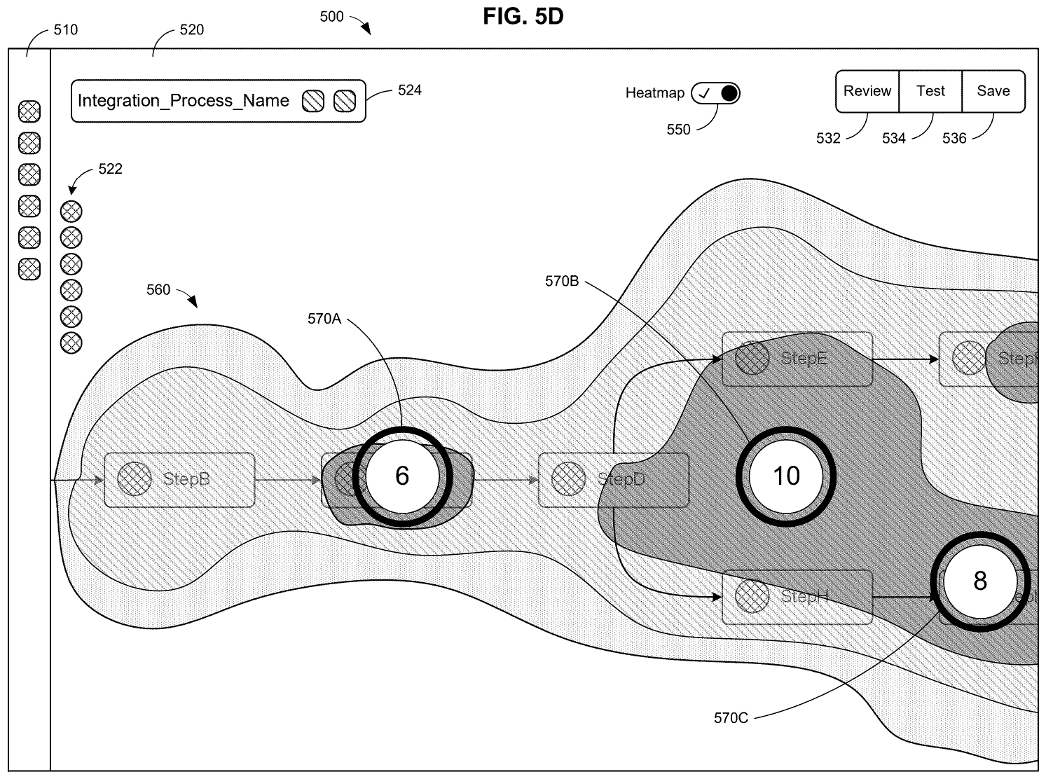

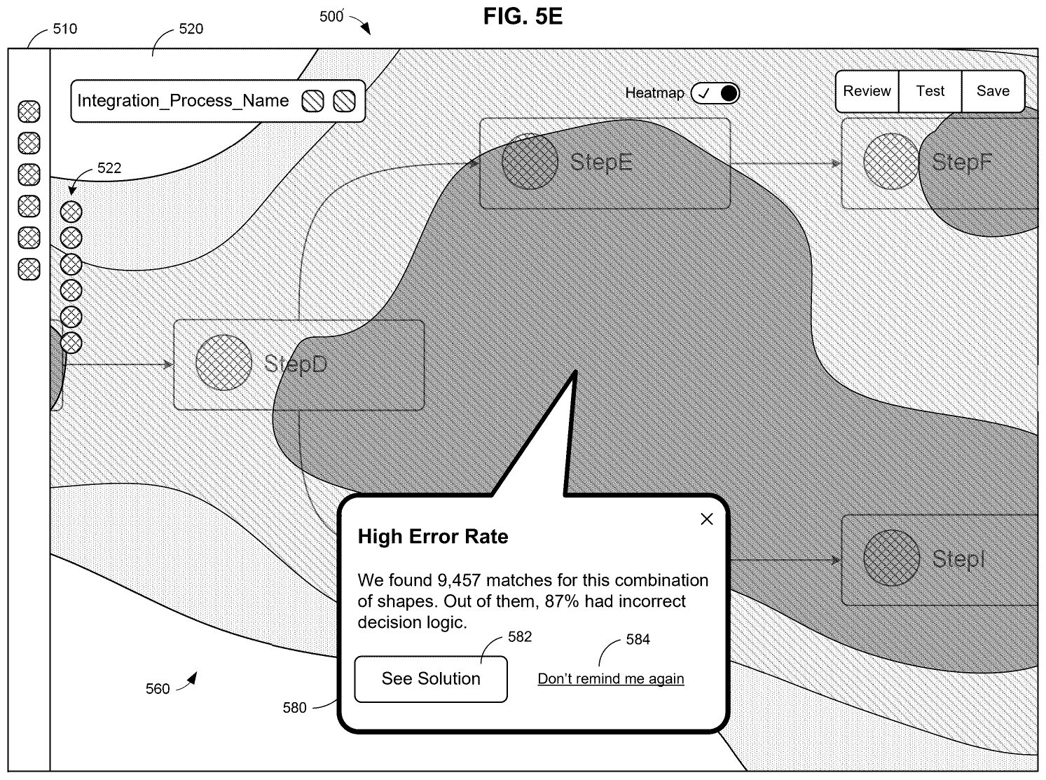

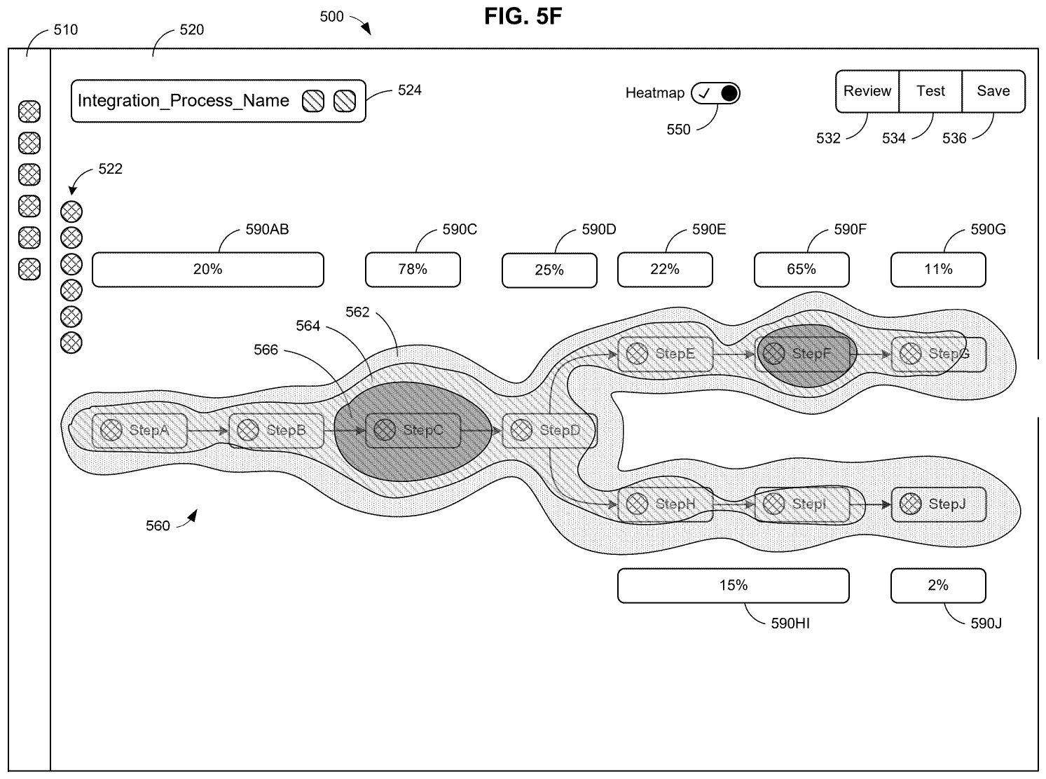

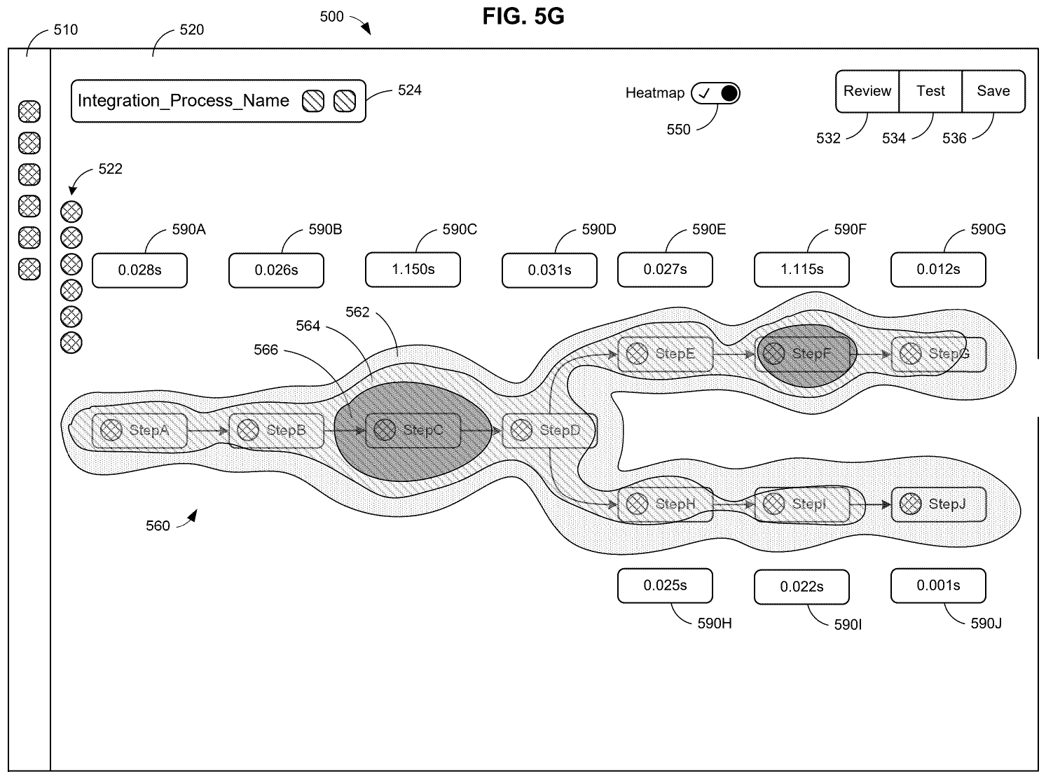

FIG. 5A illustrates an example graphical user interface 500 that may be used to construct an integration process 160, according to an embodiment. Graphical user interface 500 may be provided by user interface 150 of server application 112. In the illustrated example, graphical user interface 500 comprises a navigation bar 510 and a virtual canvas 520. Virtual canvas 520 enables a user to drag and drop representations (i.e., “shapes”) of steps at positions within an integration process 160 to be constructed, and connect those representations to form one or more paths for data to flow through the integration process 160.

Virtual canvas 520 may comprise a shape palette 522, from which new shapes can be dragged and dropped on virtual canvas 520, and a header 524 which may comprise information (e.g., name) for the integration process 160 as a whole. In addition, virtual canvas 520 may comprise a review input 532 for triggering the error prediction function and/or other analysis for integration process 160, a test input 534 for testing integration process 160 (e.g., executing integration process 160 in a test environment), and a save input 536 for saving integration process 160 in the current configuration (e.g., triggering module 320).

In the illustrated example, a user has constructed an integration process 160 with shapes 540A, 540B, 540C, 540D, 540E, 540F, 540G, 540H, 540I, and 540J, which each represents a step in integration process 160. Each of shapes 540 is connected to at least one adjacent shape 540 by a connection 545. In the illustrated example, shape 540A is connected to shape 540B by connection 545AB, shape 540B is connected to shape 540C by connection 545BC, shape 540C is connected to shape 540D by connection 545CD, shape 540D represents a branch that is connected to shape 540E by connection 545DE and is connected to shape 540H by connection 545DH, shape 540E is connected to shape 540F by connection 545EF, shape 540F is connected to shape 540G by connection 545FG, shape 540H is connected to shape 540I by connection 545HI, and shape 540I is connected to shape 540J by connection 545IJ. Because shape 540D represents a branch, there are two possible paths through integration process 160: 540A-540B-540C-540D-540E-540F-540G; and 540A-540B-540C-540D-540H-540I-540J.

As illustrated, graphical user interface 500 comprises a heatmap input 550, which enables the user to toggle on or off the heatmap. In particular, when the heatmap is deactivated, as in the illustrated example, heatmap input 550 indicates that the heatmap is off. In this state, when heatmap input 550 is selected, the heatmap is activated (e.g., by module 360).

FIG. 5B illustrates graphical user interface 500 after the user has selected heat map input 550 to activate the heatmap, according to an embodiment. Accordingly, heatmap input 550 has been updated to indicate that the heatmap is on. In this example, the heatmap is illustrated at the level representing the lowest resolution, which consists of only a color map 560. Color map 560 may comprise a plurality of color regions positioned over areas of integration process 160 to which the performance metric(s), represented by the color regions, pertain.

In this example, color map 560 comprises a first color 562, a second color 564, and a third color 566. First color 562 (e.g., green) may represent positive performance, second color 564 (e.g., yellow) may represent neutral performance, and third color 566 (e.g., red) may represent negative performance. The total size of the area covered by a particular color region may represent or otherwise be based on the number of issues that fall within the category of performance (e.g., positive, negative, or neutral) represented by that color, the number of historical execution results that fall within the category of performance represented by that color (e.g., when execution results are available for integration process 160), the number of historical integration process 160 comprising the same configuration of one or more steps and whose execution results fell within the category of performance represented by that color (e.g., when the performance metric(s) are predicted for integration process 160), the severity or extent of the category represented by that color, and/or the like. More generally, the size of each color region may be based on the value of each performance metric corresponding to the area of integration process 160 to which the color region pertains. In an embodiment, regions of third color 566, representing negative performance, may be positioned in the center of the area whose performance is being conveyed, regions of second color 564, representing neutral performance, may be positioned peripheral to any region of third color 566 for the same area, and regions of first color 562, representing positive performance, may be positioned peripheral to any region of second color 564 and third color 566 for the same area. This configuration of colors conveys a visual topography that intuitively conveys, to the user, the extent of performance issues for each area of integration process 160. AS illustrated, the color topographies for adjacent areas may be blended together to provide smooth color transitions across the entire color map 560.

In the illustrated example, the positioning of third color 566 conveys that StepC and StepF are associated with negative performance, and that the combination of StepD, StepE, StepH, and StepI are also associated with negative performance. The remaining steps are either associated with positive or neutral performance, as indicated by first color 562 and second color 564, respectively, or not associated with any performance metrics (e.g., for the displayed layer), as indicated by no color.

FIG. 5C illustrates graphical user interface 500 after the user has zoomed in to virtual canvas 520, according to an embodiment. In this embodiment, the heatmap comprises a plurality of levels of resolution, and the next level of resolution, immediately above the lowest level of resolution, is illustrated. At this next level of resolution, the heatmap comprises color map 560 and indicators 570 that convey additional details about the performance metrics for one or more areas. In particular, each indicator 570 conveys the reason for negative performance in the corresponding area of integration process 160. For instance, indicators 570 may be provided for each area, currently visible within virtual canvas 520, that is associated with negative performance (e.g., as expressed by third color 566). In this example, indicator 570A comprises a key icon, which indicates that the negative performance for StepC is related to security, and a percentage of historical execution results of the current integration process 160 that had negative performance for StepC, or the percentage of historical integration processes 160 that comprised StepC and had negative performance. Similarly, indicator 570B comprises a gear icon, which indicates that the negative performance for the combination of StepD, StepE, StepH, and StepI is related to their configuration, and a percentage of historical execution results of the current integration process 160 that had negative performance for this combination of steps, or the percentage of historical integration processes 160 that comprised the same combination of steps and had negative performance in this area.

FIG. 5D illustrates graphical user interface 500 after the user has zoomed in to virtual canvas 520, according to an alternative embodiment for the next level of resolution. As in the preceding embodiment, at this next level of resolution, the heatmap comprises color map 560 and indicators 570 that convey additional details about the performance metrics for one or more areas. However, in this alternative embodiment, each indicator 570 conveys a value of the performance metric for a corresponding area of negative performance within integration process 160 (e.g., as expressed by third color 566). In this particular example, the value in each indicator 570 may comprise the number of errors in the execution results for the current integration process 160, or predicted for the current integration process 160, for the respective area of integration process 160.

FIG. 5E illustrates graphical user interface 500 after the user has further zoomed in to virtual canvas 520, according to an embodiment. In this embodiment, the heatmap comprises a plurality of levels of resolution, and the highest level of resolution is illustrated. At this highest level of resolution, the heatmap comprises color map 560 and an indicator 580 that includes a dialog box conveying additional details about the performance metrics for each area of negative performance that is currently visible within virtual canvas 520. The dialog box comprises a natural-language expression describing the performance issue, which, in this case, is a predicted performance problem based on other integration processes 160 for which historical integration data have been collected. The dialog box may also comprise an input 582 for viewing a suggested solution to the performance problem (e.g., predicted by an error resolution model) and/or an input 584 for dismissing the dialog box.

FIG. 5F illustrates graphical user interface 500, according to an embodiment. The illustrated example may be one of a plurality of levels in a heatmap or the only level in the heatmap. In this embodiment, the heatmap comprises color map 560 and indicators 590 that convey the values of a performance metric for all areas of integration process 160. For instance, indicator 590AB comprises the value of the performance metric for the area consisting of StepA and StepB, indicator 590C comprises the value of the performance metric for the area consisting of StepC, indicator 590D comprises the value of the performance metric for the area consisting of StepD, indicator 590E comprises the value of the performance metric for the area consisting of StepE, indicator 590F comprises the value of the performance metric for the area consisting of StepF, indicator 590G comprises the value of the performance metric for the area consisting of StepG, indicator 590HI comprises the value of the performance metric for the area consisting of StepH and StepI, and indicator 590J comprises the value of the performance metric for the area consisting of StepJ. In this specific example, the performance metric is bandwidth utilization. Notably, in this example, each indicator 590 is positioned along a vertical axis with respect to the area of integration process 160 to which it corresponds. As illustrated, the indicator 590 for adjacent components may be combined if the values of the performance metric are identical or when the performance metric is only provided for the combination of components.

FIG. 5G illustrates graphical user interface 500, according to an alternative example. This example is identical to the example in FIG. 5F, except that each indicator 590 comprises the average processing time, instead of bandwidth utilization, as the performance metric. Alternatively, each indicator 590 could comprise a percentage of the average processing time of each corresponding area, relative to the total average processing time of integration process 160. Again, each indicator 590 is positioned along a vertical axis with respect to the area of integration process 160 to which it corresponds.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
generate a graphical user interface comprising a virtual canvas on which shapes, representing components of an integration process, are dragged and dropped to construct the integration process;
apply a performance model to integration data, defining the components of integration process, to generate performance data, wherein the performance data comprise one or more performance metrics for each component of the integration process;
generate a heatmap comprising a color map, wherein the color map is generated by, for each component of the integration process,
mapping at least one value of the one or more performance metrics for that component to at least one color value within a color spectrum, and
adding the at least one color value to the color map at a position that corresponds to the shape, representing that component, on the virtual canvas; and
display the heatmap as an overlay over the shapes on the virtual canvas in the graphical user interface.

2. The method of claim 1, wherein the heatmap is displayed in response to a user selection of an input within the graphical user interface.

3. The method of claim 2, further comprising using the at least one hardware processor to remove the heatmap from the graphical user interface in response to a subsequent user selection of the input.

4. The method of claim 1, wherein the performance model comprises a predictive model that predicts a value of at least one of the one or more performance metrics based on the integration data.

5. The method of claim 4, further comprising using the at least one hardware processor to train the predictive model using historical integration data from a plurality of integration platforms managed through an integration platform as a service (iPaaS) platform.

6. The method of claim 5, wherein each of the plurality of integration platforms is managed by a different organizational account than one or more other ones of the plurality of integration platforms.

7. The method of claim 4, wherein the at least one performance metric comprises one or more of a number of errors, a severity of errors, a data throughput, a bandwidth utilization, a data volume, or a processing time.

8. The method of claim 1, wherein the one or more performance metrics comprise one or more of a number of errors, a severity of errors, a data throughput, a bandwidth utilization, a data volume, or a processing time.

9. The method of claim 1, wherein the one or more performance metrics are a plurality of performance metrics, wherein the plurality of performance metrics are divided into a plurality of layers, wherein the graphical user interface comprises one or more inputs for toggling on and off each of the plurality of layers, and wherein the heatmap represents all of the plurality of layers that are toggled on.

10. The method of claim 9, wherein the graphical user interface is configured to zoom in to the virtual canvas in response to a first user operation and zoom out of the virtual canvas in response to a second user operation, wherein the heatmap comprises a plurality of levels, including a first resolution and a second resolution, and wherein the method further comprises using the at least one hardware processor to:
when zooming in to the virtual canvas, transition from the first resolution to the second resolution; and
when zooming out of the virtual canvas, transition from the second resolution to the first resolution.

11. The method of claim 10, wherein one of the plurality of levels, representing a lowest resolution, consists of the color map.

12. The method of claim 11, wherein at least one of the plurality of levels, other than the one of the plurality of levels representing the lowest resolution, comprises the color map overlaid with one or more indicators, and wherein each of the one or more indicators provides information about a performance of an area of the integration process and is overlaid over the color map at a position that corresponds to that area.

13. The method of claim 12, wherein at least one of the one or more indicators comprises a value of at least one of the one or more performance metrics.

14. The method of claim 12, wherein at least one of the one or more indicators comprises a natural-language expression that describes the performance of the area.

15. The method of claim 14, further comprising using the at least one hardware processor to generate the natural-language expression by:
generating a prompt using at least a portion of the performance data; and
inputting the prompt to a generative language model to produce the natural-language expression.

16. The method of claim 1, wherein the heatmap comprises, for each of a plurality of areas of the integration process on the virtual canvas, a color topography, and wherein the color topography comprises at least a first color region around a center of the area and a second color region around a periphery of the first color region.

17. The method of claim 16, wherein the color topographies for adjacent ones of the plurality of areas are blended together.

18. The method of claim 16, wherein, for each of the plurality of areas, a size of the first color region and a size of the second color region are based on a value of the one or more performance metrics corresponding to that area.

19. A system comprising:
at least one hardware processor; and
software that is configured to, when executed by the at least one hardware processor,
generate a graphical user interface comprising a virtual canvas on which shapes, representing components of an integration process, are dragged and dropped to construct the integration process,
apply a performance model to integration data, defining the components of integration process, to generate performance data, wherein the performance data comprise one or more performance metrics for each component of the integration process,
generate a heatmap comprising a color map, wherein the color map is generated by, for each component of the integration process,
mapping at least one value of the one or more performance metrics for that component to at least one color value within a color spectrum, and
adding the at least one color value to the color map at a position that corresponds to the shape, representing that component, on the virtual canvas, and display the heatmap as an overlay over the shapes on the virtual canvas in the graphical user interface.

20. A non-transitory computer-readable medium having instructions stored therein, wherein the instructions, when executed by a processor, cause the processor to:
generate a graphical user interface comprising a virtual canvas on which shapes, representing components of an integration process, are dragged and dropped to construct the integration process;
apply a performance model to integration data, defining the components of integration process, to generate performance data, wherein the performance data comprise one or more performance metrics for each component of the integration process;
generate a heatmap comprising a color map, wherein the color map is generated by, for each component of the integration process,
mapping at least one value of the one or more performance metrics for that component to at least one color value within a color spectrum, and
adding the at least one color value to the color map at a position that corresponds to the shape, representing that component, on the virtual canvas; and
display the heatmap as an overlay over the shapes on the virtual canvas in the graphical user interface.
